(19) United States
(12) Patent Application Publication
(10) Pub. No.: US 2021/0025413 A1
(43) Pub. Date: Jan. 28, 2021

(54) ELECTRICITY GENERATION SYSTEM

(71) Applicant: SHIH-JUNG WANG, Taoyuan City (TW)

(72) Inventor: SHIH-JUNG WANG, Taoyuan City (TW)

(21) Appl. No.: 16/720,007

(22) Filed: Dec. 19, 2019

(30) Foreign Application Priority Data
Jul. 26, 2019 (TW) 108126484

(51) Int. Cl. F15B 21/048; F04D 25/06

(52) U.S. Cl. CPC F15B 21/048; F04D 25/0673

(57) ABSTRACT

An electricity generation system includes a pneumatic generator, an air compressor, a battery module, a control module, a gas ejection module, an output circuit, a loopback circuit, and a switch. The control module controls the battery module to supply power to the air compressor, so that the air compressor is activated to generate and store compressed air in the gas cylinder. The control module controls the gas ejection module to allow the compressed air stored in the gas cylinder to enter the pneumatic generator so that the pneumatic generator generates electrical energy. The output circuit is connected to the pneumatic generator and the device to be powered. The loopback circuit connects the pneumatic generator and the battery module. The electrical energy generated by the pneumatic generator supplies the power supply device or is stored in the battery module when the switch is turned on by the control module.

### CROSS-REFERENCE TO RELATED PATENT APPLICATION

This application claims the benefit of priority to Taiwan Patent Application No. 108126484, filed on Jul. 26, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electricity generation system, and more particularly to an electricity generation system capable of returning generated electrical energy to the electricity generation system.

### BACKGROUND OF THE DISCLOSURE

Conventional electricity generation systems are systems that convert kinetic energy or other forms of energy into electrical energy, which is then delivered to various places or equipment. Nowadays, the conventional electricity generation systems generally use fossil fuels, firepower, hydropower, wind power, or solar energy as power sources. However, fossil fuel and thermal power generation are liable to cause air pollution and high energy conversion loss, resulting in poor power generation efficiency. Furthermore, hydropower, wind power, and solar power generation not only require high installation costs, power supplies of which they provide are also unstable. Moreover, hydropower, wind power, and solar power generation require a suitable environment and space to be installed.

### SUMMARY OF THE DISCLOSURE

In response to the above-referenced technical inadequacies, the present disclosure provides an electricity generation system for improving conventional electricity generation systems. For example, most of the electricity generation systems used in electric vehicles require additional electricity to initially drive relevant devices, and the additional electricity is most commonly stored in a battery. However, since the conventional electricity generation systems do not have any mechanism for charging the battery, the battery may be liable to run out of power. As a result, the electricity generation systems may not be able to drive the relevant devices.

In one aspect, an electricity generation system of the present disclosure includes a pneumatic generator, an air compressor, a battery module, a control module, a gas ejection module, an output circuit, a loopback circuit, and a switch.

The air compressor is connected to a gas cylinder. The air compressor is configured to be supplied with electricity to generate compressed air to be stored in the gas cylinder.

The battery module is connected to the air compressor. The battery module is capable of supplying the electricity to the air compressor to operate the air compressor to generate the compressed air.

The control module is connected to the battery module and the air compressor. The control module is capable of controlling the battery module to supply the electricity to the air compressor so that the air compressor is operated to generate the compressed air to be stored in the gas cylinder.

The gas ejection module is connected to the gas cylinder and the pneumatic generator. The control module is capable of controlling the gas ejection module to operate so that the compressed air stored in the gas cylinder enters the pneumatic generator to operate the pneumatic generator to generate electrical energy.

The output circuit is connected to the pneumatic generator and configured to be connected to at least one device to be powered.

The loopback circuit is connected to the pneumatic generator and the battery module.

The switch is connected to the output circuit, the loopback circuit, and the control module. The control module is capable of controlling the switch to operate between an output mode and a loopback mode. When the switch is in the output mode, the pneumatic generator is connected to the device to be powered through the output circuit. The pneumatic generator is configured to generate the electrical energy to be supplied to the device to be powered. When the switch is in the loopback mode, the pneumatic generator is connected to the battery module through the loopback circuit, and the electrical energy generated by the pneumatic generator is capable of being stored in the battery module.

Therefore, the electricity generation system of the present disclosure can be switched to the loopback mode by the switch and the control module, so that the battery module can be maintained at a predetermined power amount at any time. In addition, the gas in the gas cylinder can be maintained at a predetermined pressure, so that the gas ejection module and the pneumatic generator can be controlled to generate electrical energy at any time.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a block diagram showing a first embodiment of an electricity generation system of the present disclosure.

FIG. 2 is a block diagram showing a second embodiment of the electricity generation system of the present disclosure.

FIG. 3 is a block diagram showing a third embodiment of the electricity generation system of the present disclosure.

FIG. 4 is a block diagram showing a fourth embodiment of the electricity generation system of the present disclosure.

FIG. 5 is a block diagram showing a fifth embodiment of the electricity generation system of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

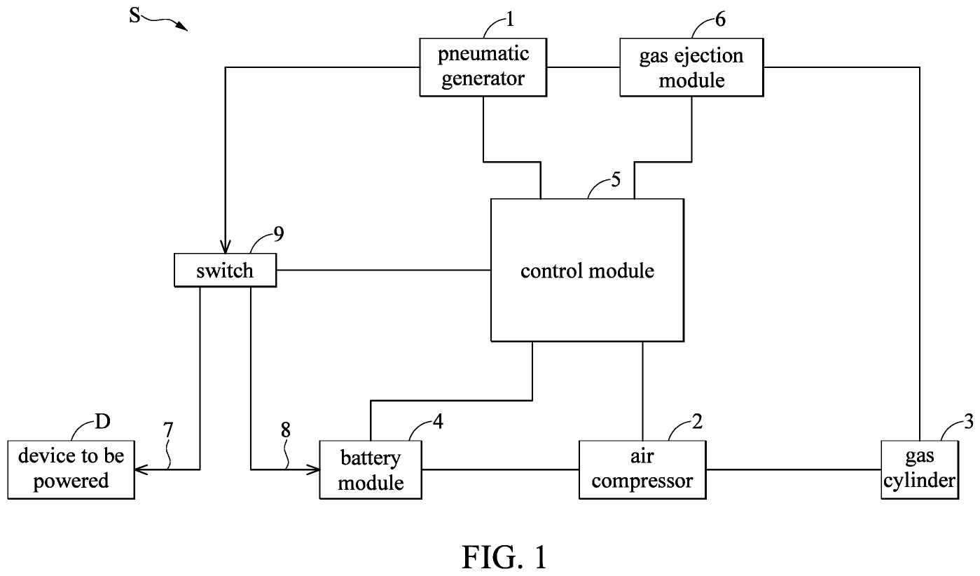

Referring to FIG. 1, a block diagram showing an electricity generation system of the present disclosure is illustrated. An electricity generation system S includes a pneumatic generator 1, an air compressor 2, a battery module 4, a control module 5, a gas ejection module 6, an output circuit 7, a loopback circuit 8, and a switch 9. The control module 5 is electrically connected to the pneumatic generator 1, the air compressor 2, the gas ejection module 6, and the switch 9. The control module 5 can control the pneumatic generator 1, the air compressor 2, the gas ejection module 6, and the switch 9 according to different conditions. The control module 5 as referred to herein may include, for example, a control chip, a microprocessor, and related control electronic components, but are not limited thereto and may be changed according to requirements.

In different applications, the control module 5 can also include a central controller and a plurality of auxiliary controllers. The auxiliary controllers are connected to the pneumatic generator 1, the air compressor 2, the gas ejection module 6, and the switch 9. The central controller is connected to the auxiliary controllers. The central controller is configured to receive a control signal of an external electronic device, and control a corresponding auxiliary controller. That is, the central controller may control the pneumatic generator 1, the air compressor 2, the gas ejection module 6, and the switch 9 through the auxiliary controllers. In contrast, the external electronic device may directly control a corresponding component through each of the auxiliary controllers.

The air compressor 2 is connected to a gas cylinder 3. The air compressor 2 can be powered to generate compressed air for storage to the gas cylinder 3. In practical applications, the control module 5 can control the battery module 4 to supply power to the air compressor 2, so that the air compressor 2 can generate the compressed air. In practical applications, a form, a shape, a size, or a compression ratio of the air compressor 2 may be changed according to the requirements of the electricity generation system S, and the present disclosure is not limited thereto. In practical applications, the air compressor 2 may be connected to a plurality of gas cylinders 3 through a plurality of pipelines, and each of the pipelines may be disposed with a gas valve. The control module 5 may be configured to control any one of the valves, so as to select which gas cylinder 3 the compressed air generated by the air compressor 2 should enter.

The gas ejection module 6 is connected to the gas cylinder 3 and the pneumatic generator 1. The control module 5 can control the gas ejection module 6 to operate so that the compressed air stored in the gas cylinder 3 enters the pneumatic generator 1, so that the pneumatic generator 1 operates to generate electrical energy. In practical applications, internal components of the pneumatic generator 1 may be, for example, turbine blades. After the compressed air ejected by the gas ejection module 6 enters the pneumatic generator 1, the turbine blade may be pushed to rotate so that the turbine blades rotate relatively to the stator in the pneumatic generator 1, thereby converting mechanical energy into electrical energy.

The output circuit 7 is connected to the pneumatic generator 1. The output circuit 7 is also connected to at least one device to be powered D, and the device to be powered D can receive the electrical energy generated by the pneumatic generator 1 through the output circuit 7. In practical applications, the output circuit 7 may be disposed with voltage processing units or current processing units according to requirements, thereby converting the electrical energy generated by the pneumatic generator 1 into a voltage, a current, etc. required by the device to be powered D.

The loopback circuit 8 is connected to the pneumatic generator 1 and the battery module 4. The switch 9 is connected to the output circuit 7 and the loopback circuit 8, and the switch 9 is connected to the control module 5. The control module 5 can control the switch 9 to operate between an output mode and a loopback mode. When the switch 9 is in the output mode, the pneumatic generator 1 is connected to the device to be powered D through the output circuit 7, and the pneumatic generator 1 is configured to generate the electrical energy to be supplied to the device to be powered D. When the switch 9 is in the loopback mode, the pneumatic generator 1 is connected to the battery module 4 through the loopback circuit 8, and the electrical energy generated by the pneumatic generator 1 is capable of being stored in the battery module 4.

### Second Embodiment

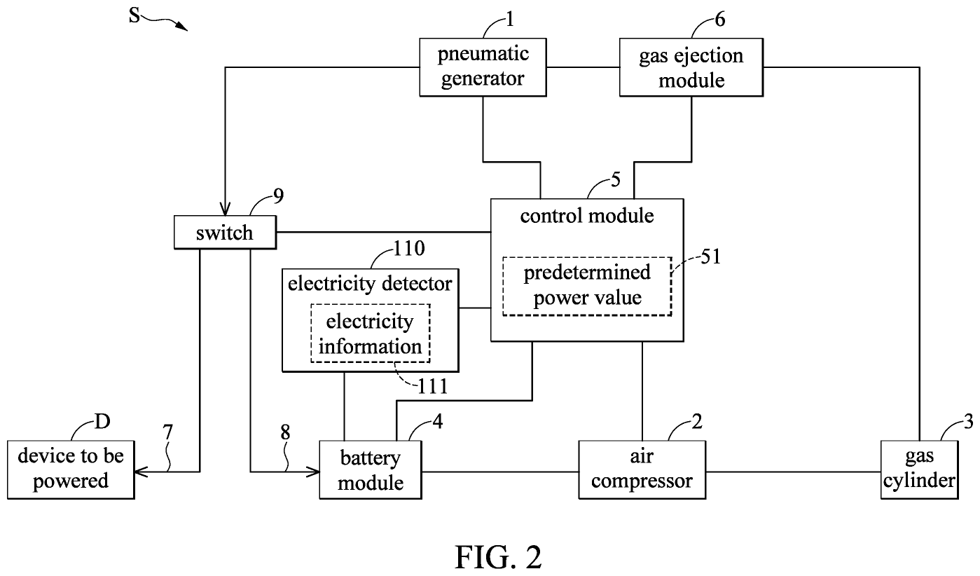

Referring to FIG. 2, the greatest difference between the second embodiment and the first embodiment is that the electricity generation system S can further include an electricity detector 110. The electricity detector 110 is configured to detect a power of the battery module 4 to generate an electricity information 111. When the control module 5 receives the electricity information 111 and determines that the power of the battery module 4 is lower than a predetermined power value 51, the control module 5 switches the switch 9 to the loopback mode, so that the electrical energy generated by the pneumatic generator 1 is stored in the battery module 4.

Conversely, when the control module 5 receives the electricity information 111 and determines that the power of the battery module 4 is not lower than the predetermined power value 51, the control module 5 switches the switch 9 to the output mode, so that the pneumatic generator 1 no longer charges the battery module 4. Therefore, the electricity detector 110 can ensure that the battery module 4 stores enough power for the air compressor 2 to operate. In a practical application, the predetermined power value 51 may be stored in the control module 5, and the electricity detector 110 may send the electricity information 111 to the control module 5 at regular intervals.

In a different embodiment, the predetermined power value 51 may also be stored in the electricity detector 110, and the electricity detector 110 may determine the current power of the battery module 4 by itself. When the electricity detector 110 determines that the current power of the current battery module 4 is lower than the predetermined power value 51, the electricity detector 110 can send a charging signal to the control module 5. When the control module 5 receives the charging signal, the control module 5 controls the switch 9 to operate so that the switch 9 is switched to the loopback mode, and pneumatic generator 1 charges the battery module 4.

According to the above configuration, a design of the loopback mode ensures that the battery module 4 maintains a predetermined amount of power at any time, and ensures that the air compressor 2 can be controlled to operate to generate the compressed air at any time. In addition, the electrical energy required for the operation of the control module 5 may also be supplied through the battery module 4. In practical applications, the battery module 4 may also be connected to other devices to obtain electrical energy, and is not limited to obtaining electrical energy through the pneumatic generator 1.

In addition, if the control module 5 controls the switch 9 so that the pneumatic generator 1 charges the battery module 4, but the power of the battery module 4 continues to be lower than the predetermined power value 51, the control module 5 can control a related warning device to send a corresponding warning signal. For example, a warning light is controlled to blink or a sounding unit is controlled to make a predetermined sound, thereby reminding a user that the battery module 4 may be malfunctioning.

### Third Embodiment

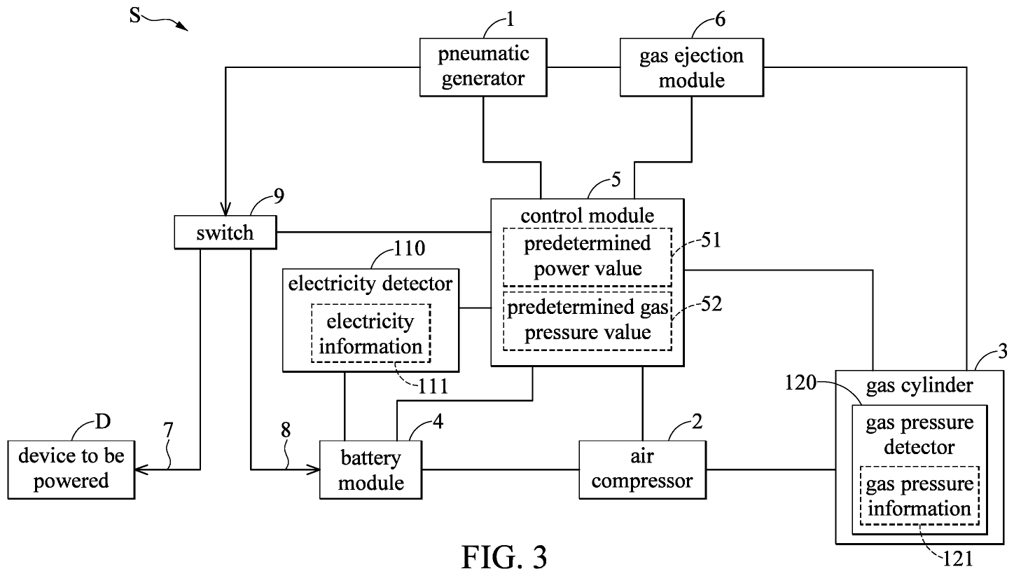

Referring to FIG. 3, the greatest difference between the third embodiment and the second embodiment is that the electricity generation system S can further include a gas pressure detector 120. The gas pressure detector 120 is configured to detect a gas pressure in the gas cylinder 3 to generate a gas pressure information 121.

When the control module 5 receives the gas pressure information 121 and determines that the gas pressure in the gas cylinder 3 is lower than a predetermined gas pressure value 52, the control module 5 controls the air compressor 2 to operate so that the air compressor 2 generates the compressed air to be stored in the gas cylinder 3. Conversely, when the control module 5 receives the gas pressure information 121 and determines that the gas pressure in the gas cylinder 3 is not lower than the predetermined gas pressure value 52, the control module 5 controls the air compressor to stop operating so that the air compressor 2 no longer generates the compressed air to be stored in the gas cylinder 3. The predetermined gas pressure value 52 may be stored in the control module 5.

By a configuration of the gas pressure detector 120, the electricity generation system S can ensure that the compressed air in the gas cylinder 3 is maintained at a predetermined gas pressure value at any time, so that the gas cylinder 3 has sufficient compressed air for the pneumatic generator 1 to generate electricity. In addition, by the configuration of the gas pressure detector 120, the electricity generation system S can also confirm whether or not the gas cylinder 3 is leaking. More specifically, the control module 5 controls the air compressor 2 to operate to generate the compressed air and store the compressed air in the gas cylinder 3, and the control module 5 continuously determines the gas pressure in the gas cylinder 3. When the control module 5 determines that the gas pressure in the gas cylinder 3 is lower than the predetermined gas pressure value 52, the control module 5 can control the related warning device (e.g., a specific broadcast unit or a warning light, etc.) to warn the user that the air compressor 2, the gas pressure detector 120, or the gas cylinder 3 may be malfunctioning.

### Fourth Embodiment

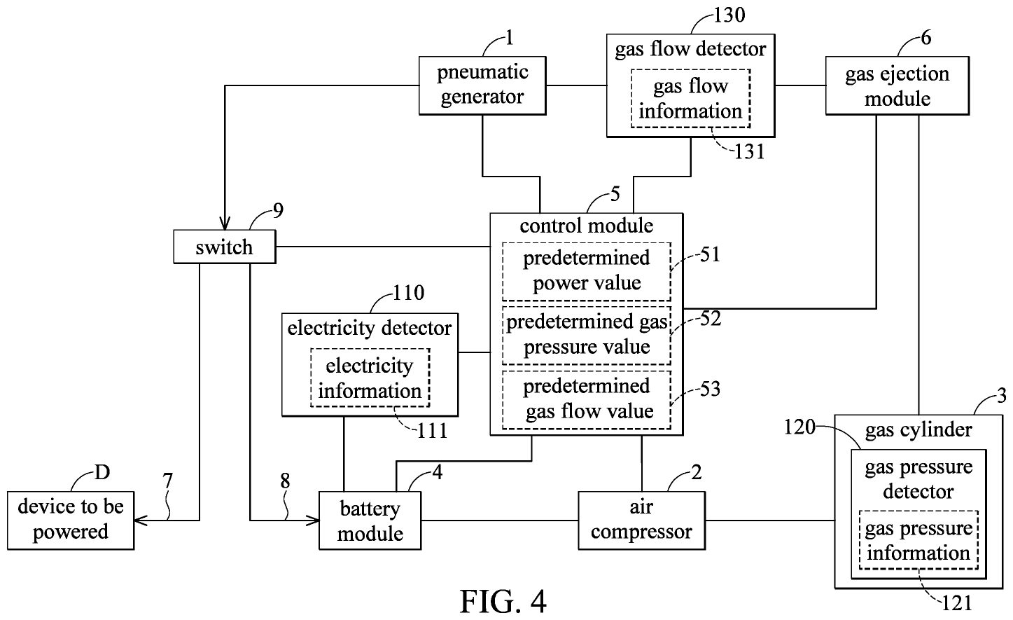

Referring to FIG. 4, the greatest difference between the fourth embodiment and the third embodiment is that the electricity generation system S can further include a gas flow detector 130. The gas flow detector 130 is disposed between the gas ejection module 6 and the pneumatic generator 1, and the gas flow detector 130 is configured to detect a gas flow volume that enters the pneumatic generator 1 through the gas ejection module 6 to generate a gas flow information 131. The control module 5 is capable of controlling the gas ejection module 6 according to the gas flow information 131 to change the gas flow volume that enters the pneumatic generator 1 through the gas ejection module 6. More specifically, the gas ejection module 6 may have a flow regulating valve, and the control module 5 can control the flow regulating valve to change a flow rate of the gas ejected by the gas ejection module 6.

When the control module 5 receives the gas flow information 131 and determines that the gas flow volume entering the pneumatic generator 1 through the gas ejection module 6 is lower than a predetermined gas flow value 53, the gas ejector module 6 is operated to increase the gas flow volume entering the pneumatic generator 1 through the gas ejection module 6. The predetermined gas flow value 53 may be stored in the control module 5. In practical applications, an amount of electricity generated by the pneumatic generator 1 has a positive correlation with the flow of gas into the pneumatic generator 1. Therefore, if the gas flow volume in the pneumatic generator 1 is lower than the predetermined gas flow value 53, it may cause the electrical energy generated by the pneumatic generator 1 to be lower than a predetermined electric quantity. Therefore, the control module 5 can adjust the gas ejection module 6 to indirectly ensure that the pneumatic generator 1 can generate a predetermined amount of electrical energy.

It is worth mentioning that, errors resulted from using the flow regulating valve for a long period of time, an insufficient gas pressure inside the gas cylinder 3, or a malfunctioning of the flow regulating valve may be reasons why the gas flow volume entering the pneumatic generator 1 is lower than the predetermined gas flow value 53. Therefore, when the control module 5 determines that a gas flow rate entering the pneumatic generator 1 through the gas ejection module 6 is lower than the predetermined gas flow value 53 so that the control module 5 controls the gas ejection module 6 to operate, and when the gas flow rate entering the pneumatic generator 1 through the gas ejection module 6 is continuously lower than the predetermined gas flow value 53, the control module 5 will control the related warning device to warn the user that some components may be malfunctioning.

### Fifth Embodiment

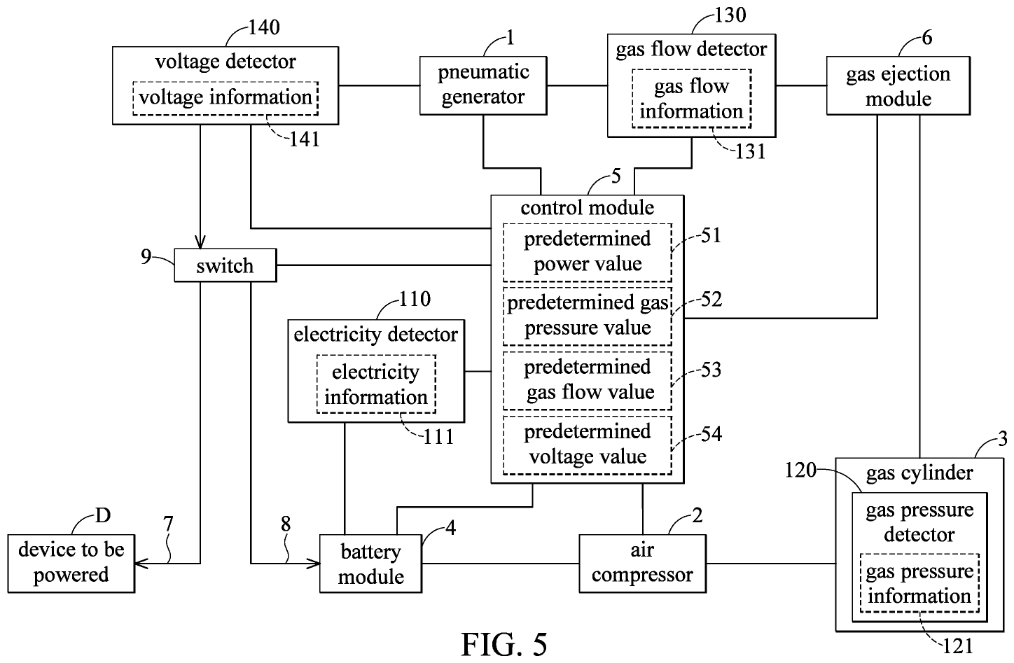

Referring to FIG. 5, the greatest difference between the fifth embodiment and the fourth embodiment is that the electricity generation system S can further include a voltage detector 140. The voltage detector 140 is connected to the pneumatic generator 1 and the output circuit 7, in which the voltage detector 140 is configured to detect a voltage of the electrical energy generated by the pneumatic generator 1 to generate a voltage information 141. The control module 5 is capable of controlling the gas ejection module 6 and the pneumatic generator 1 according to the voltage information 141 so as to change the voltage of the electrical energy generated by the pneumatic generator 1.

When the control module 5 receives the voltage information 141 and determines that the voltage of the electrical energy generated by the pneumatic generator 1 is lower than a predetermined voltage value 54, the control module 5 controls the gas ejection module 6 and the pneumatic generator 1 to operate so as to increase the electrical energy generated by the pneumatic generator 1. The predetermined voltage value 54 may be stored in the control module 5.

The control module 5 controls the gas ejection module 6 and the pneumatic generator 1 to operate to increase the electrical energy generated by the pneumatic generator 1, and the control module 5 continuously determines the voltage of the electrical energy generated by the pneumatic generator 1. When the control module 5 determines that the voltage of the electrical energy generated by the pneumatic generator 1 is lower than the predetermined voltage value 54, the control module 5 controls the related warning device to issue a warning signal to warn the user that the pneumatic generator 1 and the gas ejection module 6 may be malfunctioning. In different applications, when the control module 5 determines that the voltage of the electrical energy generated by the pneumatic generator 1 is lower than the predetermined voltage value 54, the control module 5 may also directly control the operation of the related warning device to warn the user that the pneumatic generator 1 may be malfunctioning.

In conclusion, the electricity generation system S of the present disclosure can be switched to the loopback mode by the switch 9 and the control module 5, so that the battery module 4 can be maintained at a predetermined power amount at any time. In addition, the electricity generation system S can also ensure that the gas in the gas cylinder 3 is maintained at a predetermined pressure, so that the gas ejection module 6 and the pneumatic generator 1 can be controlled to generate electrical energy at any time.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electricity generation system, comprising:
a pneumatic generator;
an air compressor being connected to a gas cylinder, wherein the air compressor is configured to be supplied with electricity to generate compressed air to be stored in the gas cylinder;
a battery module connected to the air compressor, wherein the battery module is capable of supplying the electricity to the air compressor to operate the air compressor to generate the compressed air;
a control module connected to the battery module and the air compressor, wherein the control module is capable of controlling the battery module to supply the electricity to the air compressor so that the air compressor is operated to generate the compressed air to be stored in the gas cylinder;
a gas ejection module connected to the gas cylinder and the pneumatic generator, wherein the control module is capable of controlling the gas ejection module to operate so that the compressed air stored in the gas cylinder enters the pneumatic generator to operate the pneumatic generator to generate electrical energy;
an output circuit connected to the pneumatic generator, and configured to be connected to at least one device to be powered;
a loopback circuit connected to the pneumatic generator and the battery module; and
a switch connected to the output circuit, the loopback circuit, and the control module, wherein the control module is capable of controlling the switch to operate between an output mode and a loopback mode; wherein when the switch is in the output mode, the pneumatic generator is connected to the device to be powered through the output circuit, and the pneumatic generator is configured to generate the electrical energy to be supplied to the device to be powered; wherein when the switch is in the loopback mode, the pneumatic generator is connected to the battery module through the loopback circuit, and the electrical energy generated by the pneumatic generator is capable of being stored in the battery module.

2. The electricity generation system according to claim 1, further comprising a gas pressure detector configured to detect a gas pressure in the gas cylinder to generate a gas pressure information, wherein the control module is connected to the gas pressure detector, and the control module is capable of controlling the air compressor to operate according to the gas pressure information so that the air compressor generates the compressed air to be stored in the gas cylinder.

3. The electricity generation system according to claim 2, wherein when the control module receives the gas pressure information and determines that the gas pressure in the gas cylinder is lower than a predetermined gas pressure value, the control module controls the air compressor to operate so that the air compressor generates the compressed air to be stored in the gas cylinder; wherein when the control module receives the gas pressure information and determines that the gas pressure in the gas cylinder is not lower than the predetermined gas pressure value, the control module controls the air compressor to stop operating.

4. The electricity generation system according to claim 1, further comprising an electricity detector configured to detect a power of the battery module to generate an electricity information, wherein the control module is capable of controlling the switch to operate according to the electricity information so as to switch the switch between the output mode and the loopback mode.

5. The electricity generation system according to claim 4, wherein when the control module receives the electricity information and determines that the power of the battery module is lower than a predetermined power value, the control module switches the switch to the loopback mode, so that the electrical energy generated by the pneumatic generator is stored in the battery module, and wherein when the control module receives the electricity information and determines that the power of the battery module is not lower than the predetermined power value, the control module switches the switch to the output mode.

6. The electricity generation system according to claim 1, further comprising an electricity detector configured to detect a power of the battery module, wherein when the electricity detector detects the power of the battery module and determines that the power of the battery module is lower than a predetermined power value, the electricity detector transmits a charging signal to the control module, and wherein when the control module receives the charging signal, the control module controls the switch to operate so that the switch is switched to the loopback mode, and the electrical energy generated by the pneumatic generator is stored in the battery module.

7. The electricity generation system according to claim 1, further comprising a gas flow detector disposed between the gas ejection module and the pneumatic generator, wherein the gas flow detector is configured to detect a flow of gas that enters the pneumatic generator through the gas ejection module to generate a gas flow information, and wherein the control module is capable of controlling the gas ejection module according to the gas flow information to change a gas flow volume that enters the pneumatic generator through the gas ejection module.

8. The electricity generation system according to claim 7, wherein when control module receives the gas flow information and determines that the gas flow volume entering the pneumatic generator through the gas ejection module is lower than a predetermined gas flow value, the gas ejector module is operated to increase the gas flow volume entering the pneumatic generator through the gas ejection module.

9. The electricity generation system according to claim 1, further comprising a voltage detector connected to the pneumatic generator and the output circuit, wherein the voltage detector is configured to detect a voltage of the electrical energy generated by the pneumatic generator to generate a voltage information; and wherein the control module is capable of controlling the gas ejection module and the pneumatic generator according to the voltage information so as to change the voltage of the electrical energy generated by the pneumatic generator.

10. The electricity generation system according to claim 9, wherein when the control module receives the voltage information and determines that the voltage of the electrical energy generated by the pneumatic generator is lower than a predetermined voltage value, the control module controls the gas ejection module and the pneumatic generator to operate so as to increase the electrical energy generated by the pneumatic generator.
